(19) United States
(12) Patent Application Publication
(10) Pub. No.: US 2017/0072823 A1
(43) Pub. Date: Mar. 16, 2017

(54) AUTOMOBILE FLOOR MAT

(71) Applicant: Automotive Flooring LLC, Los Angeles, CA (US)

(72) Inventor: Michael Assil, Los Angeles, CA (US)

(73) Assignee: Automotive Flooring LLC, Los Angeles, CA (US)

(21) Appl. No.: 15/359,411

(22) Filed: Nov. 22, 2016

Related U.S. Application Data
(63) Continuation-in-part of application No. 12/271,759, filed on Nov. 14, 2008, now Pat. No. 9,533,466.

(51) Int. Cl. B60N 3/04; B32B 3/08; B32B 3/26; B32B 7/04; B32B 5/02; B32B 7/08; B32B 7/12; B32B 3/06; B32B 3/30

(52) U.S. Cl. CPC B60N 3/048; B32B 3/06; B32B 3/085; B32B 3/266; B32B 3/30; B32B 5/02; B32B 7/08; B32B 7/12; B32B 7/045; B60N 3/046; B32B 2250/03; B32B 2471/04; B32B 2605/003

(57) ABSTRACT

An improved floor mat with inlays made out of wood, aluminum, carbon fiber or other decorative materials for automobiles. The floor mat has strategically placed inlays to increase durability, while also complimenting the decorative nature of the mats. The inlays are beveled in a way as to add to the aesthetic look of the floor mat. The bevel of the inlay creates seamless transition between inlay and the untrimmed carpet fibers

### BACKGROUND

1. Field of the Invention

The present invention claims priority to and incorporates herein its parent U.S. Utility patent application Ser. No. 12/271759, filed on Nov. 14, 2008.

The present invention relates to an improved automobile floor mat. Standard floor mats are primarily made of carpeting or rubber. Usually, standard factory supplied floor mats are not aesthetically pleasing. Nor do standard, factory supplied floor mats match or coordinate with the various interior trims used in modern vehicles, such as wood, aluminum or carbon fiber to name a few. Furthermore, certain areas of the mats are prone to accelerated wear.

It would be desirable to have an aftermarket automobile floor mat that provides better aesthetics and coordination with different vehicle trims, such as wood, aluminum or carbon fiber to name a few, but also improved wear and longer life.

2. Description of the Related Art

Automobile floor mats, whether factory installed or acquired in the after market, are either single pieces of carpeting or single pieces of rubber or plastic. They are made to increase comfort, and, in the case of after market mats, protect the floor from dirt and wear and for aesthetics.

### SUMMARY OF THE INVENTION

In a preferred embodiment of the present invention, a piece of wood, faux wood, aluminum, steel, carbon fiber, or any other aesthetically pleasing material is affixed to a floor mat otherwise made of carpet. The material can be affixed to a substrate layer by screws, adhesive, grommets, or a combination of such.

The novel features which are characteristic of the invention, both as to structure and method of operation thereof, together with further objects and advantages thereof, will be understood from the following description, considered in connection with the accompanying drawings, in which the preferred embodiment of the invention is illustrated by way of example. It is to be expressly understood, however, that the drawings are for the purpose of illustration and description only, and they are not intended as a definition of the limits of the invention.

### BRIEF DESCRIPTION OF THE DRAWINGS

FIG. 1 is a perspective view of an embodiment of a method in preparing a floor mat of the present invention;

FIG. 2 is a top view of an embodiment of a method in preparing a floor mat;

FIG. 3 is a cross-section view of an embodiment of a method in preparing the floor mat;

FIG. 4 is a cross-section view of a preferred embodiment of the floor mat;

FIG. 5 is a perspective view of an embodiment of a method of preparing the floor mat;

FIG. 6 is a cross-section view of an embodiment of a floor mat with an inlay;

FIG. 7 is a magnified view of a portion of FIG. 6;

FIG. 8 is a cross-section of an embodiment of a floor mat;

FIG. 9 is a cross-section of an embodiment of a floor mat;

FIG. 10 is a cross-section of an embodiment of a floor mat;

FIG. 11 is a cross-section of an embodiment of a floor mat;

FIG. 12 is a cross-section of an embodiment of a floor mat;

FIG. 13 is a cross-section of an embodiment of a floor mat;

FIG. 14 is a cross-section of an embodiment of a floor mat;

FIG. 15 is a cross-section of an embodiment of a floor mat;

FIG. 16 is an exploded perspective view of an embodiment of a floor mat;

FIG. 17 is a cross-section view of the embodiment displayed in FIG. 16;

FIG. 18 is a perspective view of an additional embodiment of the floor mat with an inlay;

FIG. 19 is a cross-section view of the embodiment displayed in FIG. 18;

FIG. 20 is a top plan view of an additional embodiment of the floor mat and a plurality of inlays;

FIG. 21 is a cross section of the embodiment displayed in FIG. 20;

FIG. 22 is a perspective view of an attachment to the outer edge of any floor mat embodiment;

FIG. 23 is a top plan view of the embodiment displayed in FIG. 22 where the attachment is attached to the body of the mat.

### DETAILED DESCRIPTION OF THE INVENTION

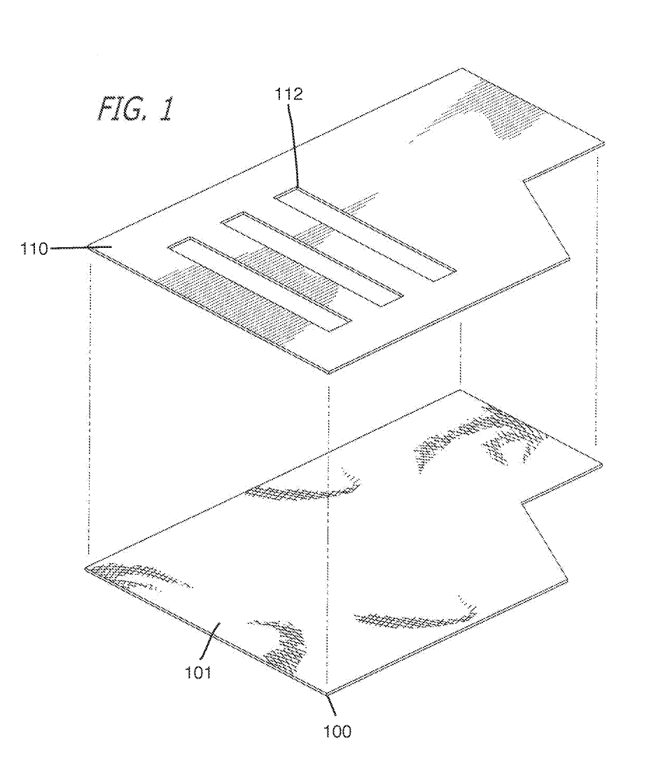

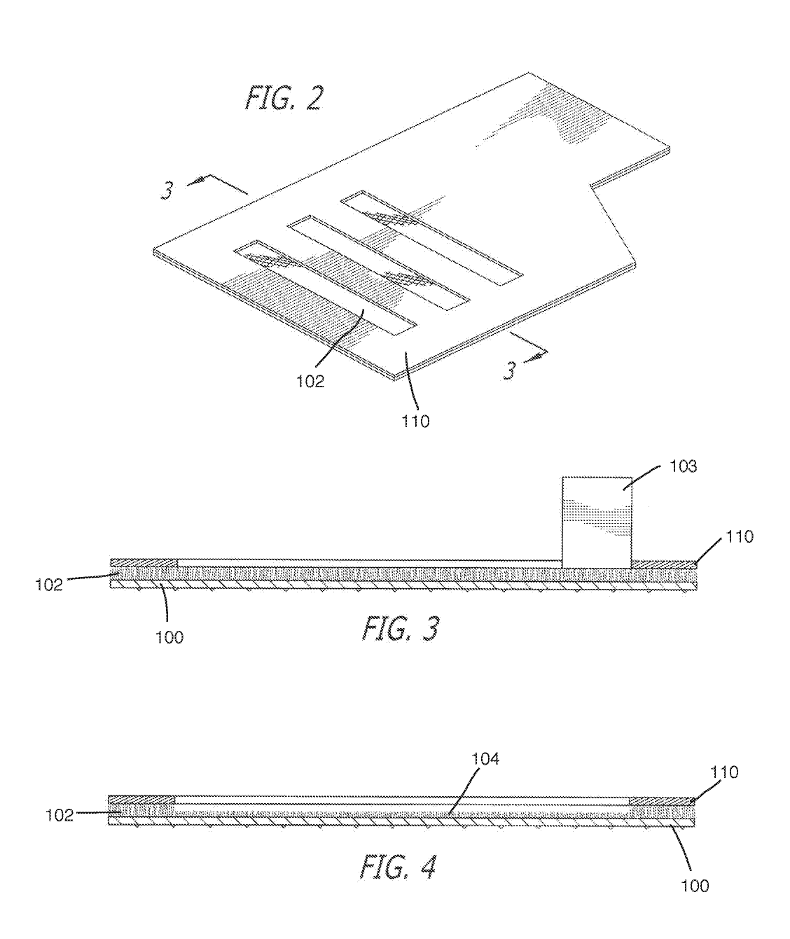

A preferred method of preparing a floor mat 100 is shown in FIG. 1. The floor mat 100 is shaped in a way to not add extra material or bulk to any of the side panels, pillars, drive shaft or any interior panels present and protruding in the seating/floor area in the automobile. This specific embodiment in FIG. 1 is made in a shape so that it does not intrude or interfere with the driver's side pedals or foot placement. It is specifically tailored to the shape of the area in the automobile in which it is to be placed.

Most automobiles have carpeting in the floor area and this floor mat is intended to be placed on top of that carpeting. The carpet layer 102 is located on the top surface of the floor mat 100. The carpet layer may also be made of other textile materials. The floor mat 100 can have various shapes and/or tapers depending on the automobile application in which it is used. A matching mat could be supplied for the passenger side as well. Also, matching mats could be supplied for the rear seats. Additionally, a matching mat could be supplied for the trunk.

A template 110 is placed over the carpet layer 102. The template 110 may be used for cutting away the carpet layer 102 within the cut out sections 108. Cutting away the carpet layer 102 may include removing the carpet fibers, cutting the carpet fibers, or shaving the carpet fibers. The shape of the cut out sections 112 substantially conforms to the shape of the inlays.

The template 110 may have an outer perimeter dimension that conforms to at least part of the outer perimeter dimensions of the floor mat 100. Other embodiments of the template may have any other outer perimeter dimensions.

The floor mat 100 may have other types of surfaces such as non-slip surface and such surfaces may be used in combination with carpeting or other types of materials(not shown).

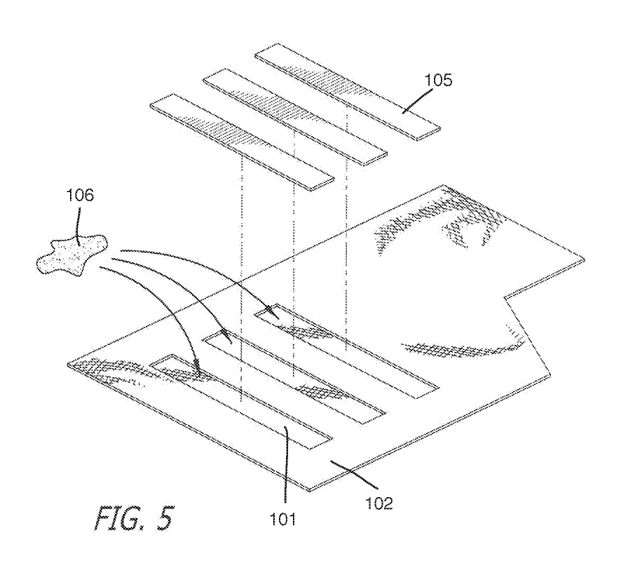

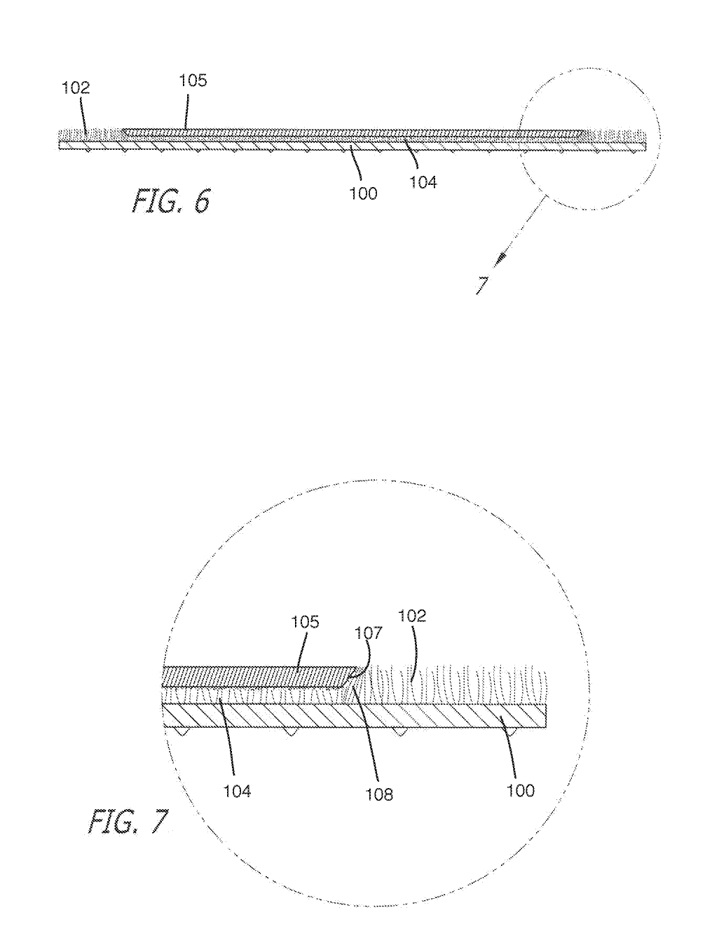

The carpet layer 102 is cut by a cutter 103 to trim or remove the carpet fibers of that section. The cutter may be any means known in the art for trimming or removing fibers. The cut carpet fibers 104 are then at a length at least less than the carpet fibers at their original length. Once the carpet fibers have been trimmed or removed, an inlay 105 may be bonded to the cut carpet fibers 104. In one exemplary embodiment, the inlay 105 may have a beveled edge 107 where inlay is bonded to the cut carpet fibers 104 in such a way that the beveled edge of the inlay 107 overlaps with the uncut carpet fibers 108. The bonding of the inlay 105 to the cut carpet fibers 104 may be achieved in a number of ways including using an adhesive 106 as displayed in FIG. 5.

An exemplary method for cutting the carpet layer 102 is displayed in FIG. 3. Said means for cutting the carpet layer 102 may be accomplished using a variety of tools including, but not limited to, a razor blade 103 and a template layer 110. The template layer 110 may be positioned atop the carpet layer 102 to allow access to the portion of the fibers that are intended to be trimmed or removed. FIG. 4 shows a method of preparing the mat where the carpet layers 102 have been trimmed or removed in a specific section of the floor mat 100 and the template layer 110 remains on top of the untrimmed areas of the carpet layer 102.

Some inlays 105 may have a beveled edge 107 at the edges of the inlay as shown in exemplary embodiment of FIG. 7. When the inlay 105 is positioned atop of the section of trimmed or removed carpet fibers 104, the beveled edge of the inlay 107 is positioned in a way where the beveled portion extends over the uncut carpet fibers 108. By extending the beveled portion 107 over the longer uncut carpet fibers 108, the beveled portion of the inlay 107 pushes the longer fibers tighter together and creates a seamless effect 108 where there is no visible seam to the viewer of the mat.

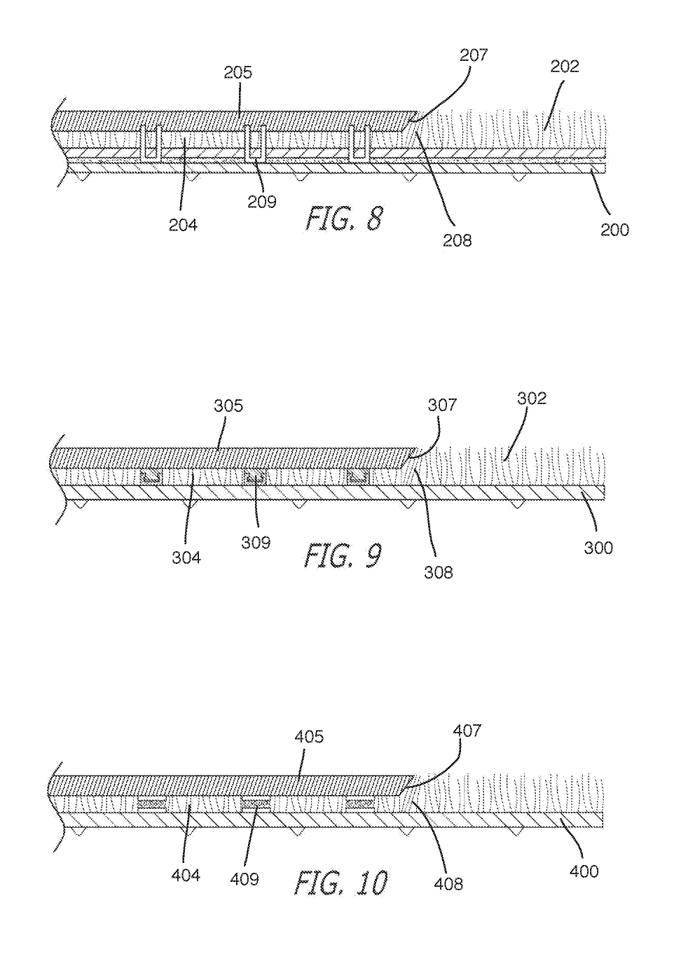

FIG. 8 displays another exemplary embodiment where a beveled inlay 205 is affixed to the cut carpet layer 204 using a staple or nail. The exemplary embodiment may be staples 209. The base portions of the staples 209 are embedded in the substrate layer 200 and extend upward into the lower portion of the inlay 205.

Another preferred embodiment may use a tongue and groove 309 to attach the inlay to the trimmed or removed portion of the carpet layer 304. The groove portion of the tongue and groove 309 may be affixed to the substrate layer 300 and the tongue portion may be affixed to the inlay 305. The tongue and groove 309 may snap into place when applying pressure of the inlay on to the cut carpet fiber 304.

FIG. 10 provides an additional method of attaching said beveled inlay portion 405 atop of the cut carpet layer 404. The preferred embodiment may use a hook and loop 409 (or Velcro) to attach the inlay 405 to the uncut carpet layer 404.

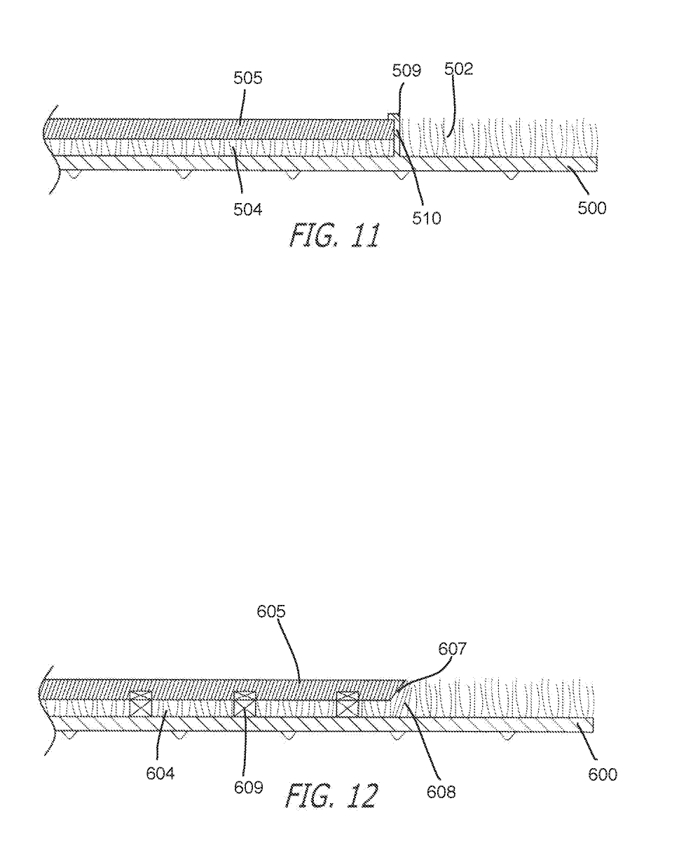

Another embodiment is a floor mat 500 with a holding structure 510 having an overhang 509 as shown in FIG. 11. The inlay 505 is placed adjacent to the holding structure. An edge of the inlay 505 may be tucked under the overhang 509 to secure the inlay 505 atop of the cut carpet portion 504. Other means to affix the inlay may be used in combination with this method. The holding structure 510 may be an entire frame around one or more edges of the inlay. The vertical arm of the holding structure may also be positioned at an angle such that the end of the holding structure is positioned over carpet fibers in a manner that is similar to embodiments with the beveled edges.

As shown in FIG. 12, an inlay portion 605 is placed atop uncut carpet layer 604. In this method of preparing a floor mat, an outcropping 609 which is affixed to the substrate layer 600, extends into a groove within the inlay. This embodiment may also be used in combination with other means of attachment including but not limited to adhesives or nails.

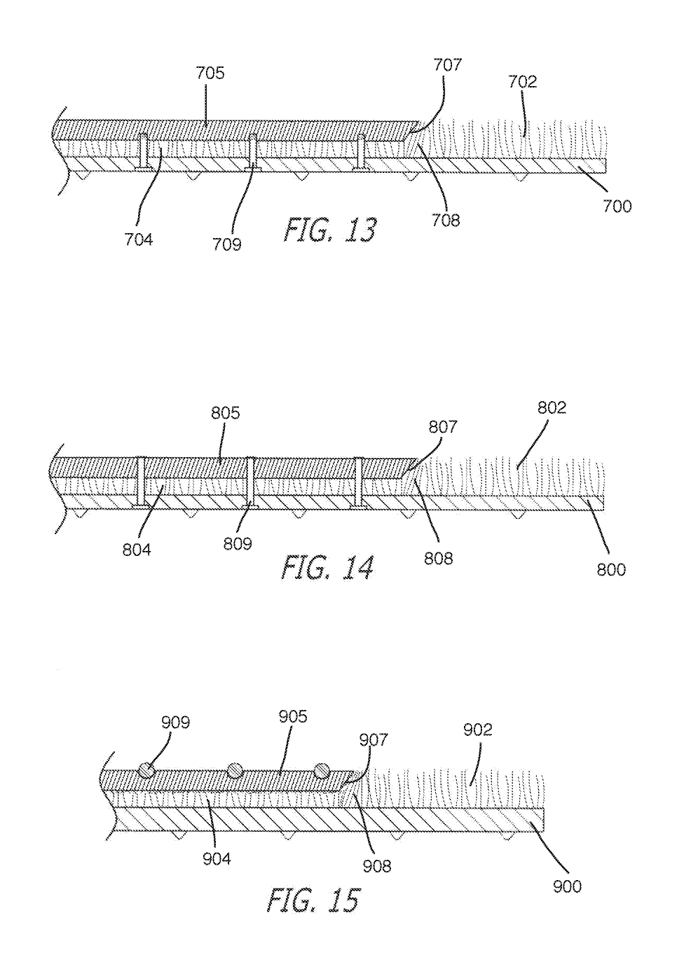

FIG. 13 is another embodiment where the inlay 705 is attached to the cut carpet layer 704 using one or more screws 709. The one or more screws 709 are mounted in or through the substrate layer 700 extending through the cut carpet fibers 704 and into at least a portion of the beveled inlay 705. FIG. 14 displays an additional method of attaching said beveled inlay 805 atop of the trimmed or removed carpet layer 804. In this method of preparing a floor mat a form of one or more nails 809 are used to attach the inlay to the trimmed or removed portion of the carpet layer 804. The one or more nails 809 are mounted in or through the substrate layer 800 extending through the trimmed or removed carpet fibers 804 and into at least a portion of the beveled inlay 805.

FIG. 15 is another embodiment where the beveled edge inlay 905 may have one or more rods 909 to be used for decorative purposes or provide a non-slip surface. The rods may be made of similar materials to the inlay or other materials such as rubber. The rods are not limited to having a circular diameter but may have any other shape such as oblong, rectangular, etc.

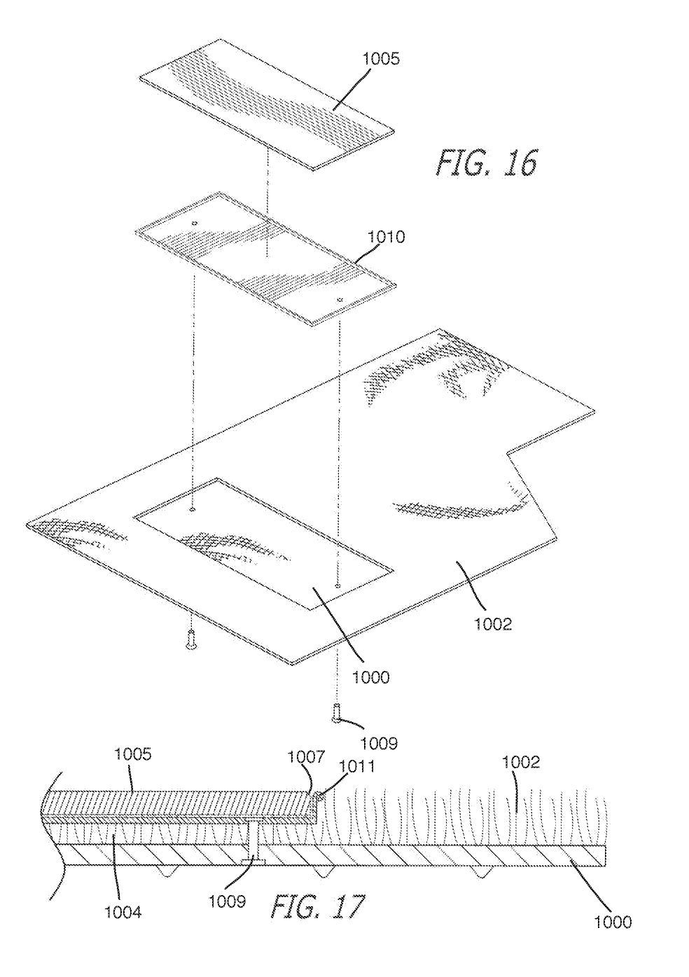

FIGS. 16 and 17 show an additional method for attaching the beveled inlay 1005 atop of the trimmed or removed carpet layer 1004 wherein the inlay comprises a tray 1010 with a beveled edge or curved edge. The dimensions of the tray are configured to fit the beveled inlay 1005. The tray may be mounted using any attachment method such as those previously described as well as with grommets 1009. The grommets 1009 in this method of preparing a floor mat are mounted in or through the substrate layer 1000 extending through the cut carpet layer 1004 and at least partially into the beveled tray 1010. The said beveled tray 1010 may extend partially upon and over the uncut carpet fibers 1011 creating the unique seamless effect desired. Said inlay may be mounted against the tray using a form of adhesive or through any method previously described.

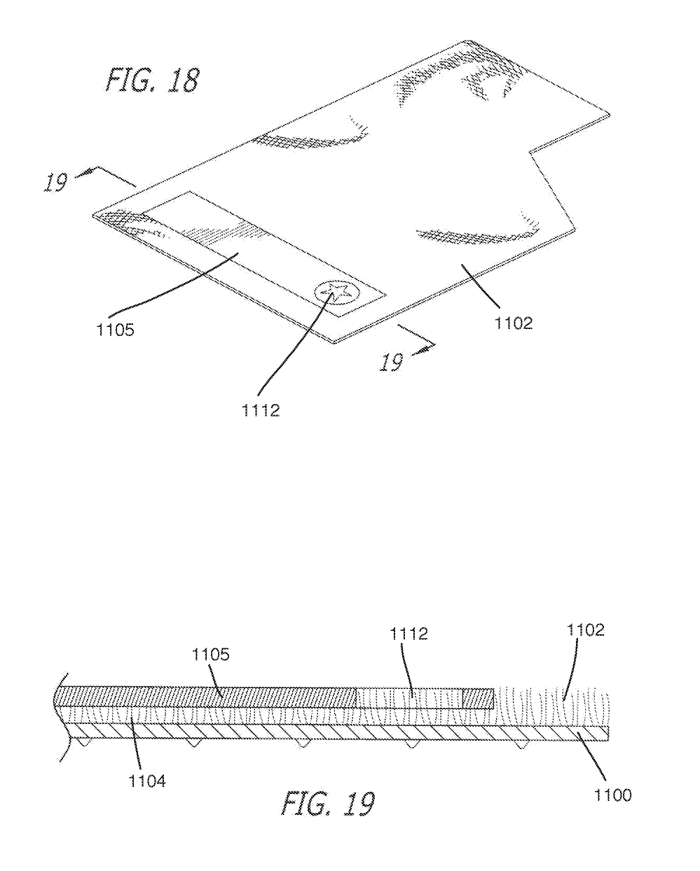

FIGS. 18 and 19 show an additional embodiment of attaching the inlay 1105 to the trimmed or removed carpet fiber portion 1104 of the floor mat. In this method of preparing a floor mat there is a carved out design portion 1112 that aligns with an untrimmed portion 1102 of the carpet fibers. The cut and uncut carpet fibers within this region may be cut to substantially match the shape of the design portion 1112. The design portion 1112 may have beveled edges that may overlap some of the uncut carpet fibers 1102.

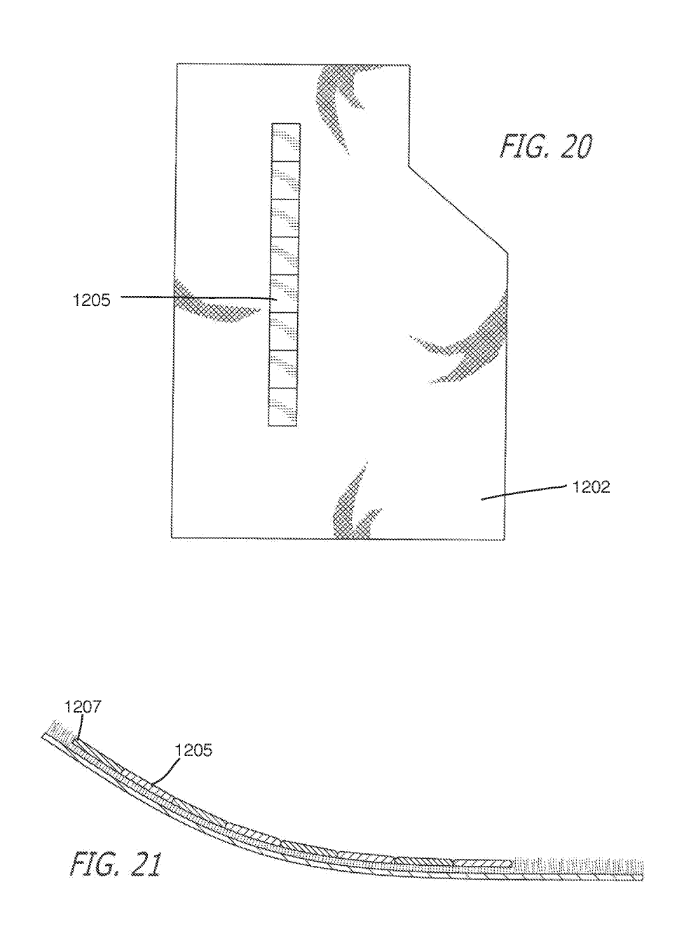

FIGS. 20 and 21 show an additional method and embodiment of attaching the beveled inlay portion 1205 where there is a plurality of inlays attached to the uncut carpet fibers. The beveled edges may be angled in an opposite manner than previously described. Here, the beveled edges may also allow for flexing of the car mat between each of the inlays.

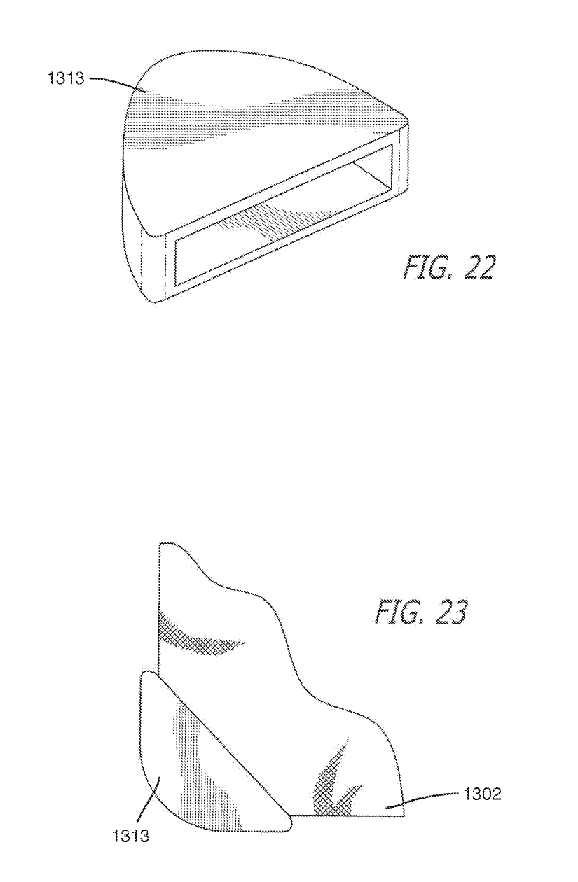

FIGS. 22 and 23 show a corner attachment piece 1313 that fits around the corners of the mat. The said attachment piece 1313 may also wrap around the top, bottom, and side edges of the mat. The attachment piece 1313 may be used for protection, prevent sliding of the mat, and for various other reasons. Additionally, said attachment piece 1313 may vary in size and thickness.

Others skilled in the art can provide yet other embodiments employing the concepts of the present invention. Accordingly, the breadth of the invention should only be limited by the scope of the claims appended hereto.

What is claimed is:

1. An automotive floor mat comprising:
a substrate layer;
the substrate layer having a top fibrous layer;
the top fibrous layer having a trimmed or removed area;
an inlay having an overall planar surface and the inlay is located at the trimmed or removed area; and
said inlay having at least one beveled edge.

2. The floor mat of claim 1 in which the at least one beveled edge overlaps with at least a portion of the surrounding untrimmed or cut fibrous layer.

3. The floor mat of claim 1 in which the inlay is flexible, semi-rigid, or rigid.

4. The automotive floor mat of claim 1 in which the beveled edge is at an angle different from 90 degrees relative to the top surface of the inlay.

5. The floor mat of claim 1 in which said inlay is affixed to said substrate layer comprising one or more screws, grommets, adhesives, staples, nails, latches, or hook and loop connectors.

6. The floor mat of claim 1 which said inlay has one or more elongated inserts located across the inlay.

7. An automotive floor mat comprising:
a substrate layer;
the substrate layer having a top fibrous layer;
the top fibrous layer having a trimmed or removed area;
an inlay having an overall planar surface and the inlay is located at the trimmed or removed area;
said inlay having at least one beveled edge; and
the at least one beveled edge overlaps with at least a portion of the surrounding untrimmed or cut fibrous layer.

8. The floor mat of claim 7 in which the inlay is flexible, semi-rigid, or rigid.

9. The automotive floor mat of claim 7 in which the beveled edge is at an angle different from 90 degrees relative to the top surface of the inlay.

10. The floor mat of claim 7 in which said inlay is affixed to said substrate layer comprising one or more screws, grommets, adhesives, staples, nails, latches, or hook and loop connectors.

11. The floor mat of claim 7 which said inlay has one or more elongated inserts located across the inlay.

12. A method of attaching an inlay into an automotive floor mat having a top fibrous layer comprising:
trimming or removing fibers from the top fibrous layer to create a cut area and an uncut area; and
attaching at least one inlay into the cut area and that the at least one inlay has one or more beveled edges and the inlays beveled edge overlaps with a portion of the adjacent uncut area.

13. The method of making a floor mat of claim 12 where trimming or removing fibers of said top fibrous layer uses a razor blade.

14. The method of making a floor mat of claim 12 where trimming or removing said top layer fibers is preceded by first laying a template where the template has at least one opening which is used to define the cut area and uncut area of the top surface layer.
